(19) United States
(12) Patent Application Publication
(10) Pub. No.: US 2020/0379951 A1
(43) Pub. Date: Dec. 3, 2020

(54) VISUALIZATION AND INTERACTION WITH COMPACT REPRESENTATIONS OF DECISION TREES

(71) Applicant: BigML, Inc., Corvallis, OR (US)

(72) Inventors: J. Justin DONALDSON, Corvallis, OR (US); Adam Ashenfelter, Corvallis, OR (US); Francisco Martin, Corvallis, OR (US); Jos Verwoerd, Corvallis, OR (US); Jose Antonio Ortega, Corvallis, OR (US); Charles Parker, Corvallis, OR (US)

(21) Appl. No.: 16/726,076

(22) Filed: Dec. 23, 2019

Related U.S. Application Data
(63) Continuation of application No. 13/667,542, filed on Nov. 2, 2012, now abandoned.
(60) Provisional application No. 61/555,615, filed on Nov. 4, 2011.

(51) Int. Cl. G06F 16/17; G06F 16/901; G06F 16/904

(52) U.S. Cl. CPC G06F 16/17; G06F 16/904; G06F 16/9027

(57) ABSTRACT

A decision tree model is generated from sample data. A visualization system may automatically prune the decision tree model based on characteristics of nodes or branches in the decision tree or based on artifacts associated with model generation. For example, only nodes or questions in the decision tree receiving a largest amount of the sample data may be displayed in the decision tree. The nodes also may be displayed in a manner to more readily identify associated fields or metrics. For example, the nodes may be displayed in different colors and the colors may be associated with different node questions or answers.

The present application is a continuation of and claims priority benefit to U.S. patent application Ser. No. 13/667,542, filed Nov. 2, 2012, which claims priority to U.S. Provisional Patent Ser. No. 61/555,615, filed Nov. 4, 2011, entitled: VISUALIZATION AND INTERACTION WITH COMPACT REPRESENTATIONS OF DECISION TREES, all of which are herein incorporated by reference in their entirety.

U.S. Provisional Patent Ser. No. 61/557,826, filed Nov. 9, 2011, entitled: METHOD FOR BUILDING AND USING DECISION TREES IN A DISTRIBUTED ENVIRONMENT; and U.S. Provisional Patent Ser. No. 61/557,539, filed Nov. 9, 2011, entitled: EVOLVING PARALLEL SYSTEM TO AUTOMATICALLY IMPROVE THE PERFORMANCE OF DISTRIBUTED SYSTEMS are herein incorporated by reference in their entireties.

### BACKGROUND

Decision trees are a common component of a machine learning system. The decision tree acts as the basis through which systems arrive at a prediction given certain data. At each node of the tree, the system may evaluate a set of conditions, and choose the branch that best matches those conditions. The trees themselves can be very wide and encompass a large number of increasingly branching decision points.

FIG. 1 depicts an example of a decision tree 100 plotted using a graphviz visualization application. Decision tree 100 appears as a thin, blurry, horizontal line due to the large number of decision nodes, branches, and text. A section 102A of decision tree 100 may be visually expanded and displayed as expanded section 102B. However, the expanded decision tree section 102B still appears blurry and undecipherable. A sub-section 104A of decision tree section 102B can be visually expanded a second time and displayed as sub-section 104B. Twice expanded sub-section 104B still appears blurry and is still hard to decipher.

Zooming into increasingly smaller sections may reduce usefulness of the decision tree. For example, the expanded decision tree sections may no longer visually display relationships that appear in the non-expanded decision tree 100. For example, the overall structure of decision tree 100 may visually contrast different decision tree nodes, fields, branches, matches, etc. and help distinguish important data model information. However, as explained above, too many nodes, branches, and text may exist to display the entire structure of decision tree 100 on the same screen.

### BRIEF DRAWINGS DESCRIPTION

FIG. 1 depicts a non-filtered decision tree.

FIG. 2 depicts a decision tree visualization system.

FIG. 3 depicts a decision tree using colors to represent node questions.

FIG. 4 depicts how colors and associated node questions may be represented in the decision tree.

FIG. 5 depicts a decision tree using colors to represent outputs.

FIG. 6 depicts a cropped version of a decision tree that uses branch widths to represent instances of sample data.

FIG. 7 depicts a decision tree displayed with a legend that cross references colors with node questions.

FIG. 8 depicts a popup window displaying a percent of sample data passing through a node.

FIG. 9 depicts a popup window showing node metrics.

FIG. 10 depicts a technique for expanding a selected decision tree node.

FIG. 11 depicts a technique for selectively pruning a decision tree.

FIG. 12 depicts a legend cross referencing node fields with importance values and colors.

FIG. 13 depicts a legend cross referencing node outputs with data count value and colors.

FIG. 14 depicts a decision tree using alpha-numeric characters to represent node questions.

FIG. 15 depicts an example computing device for implementing the visualization system.

### DETAILED DESCRIPTION

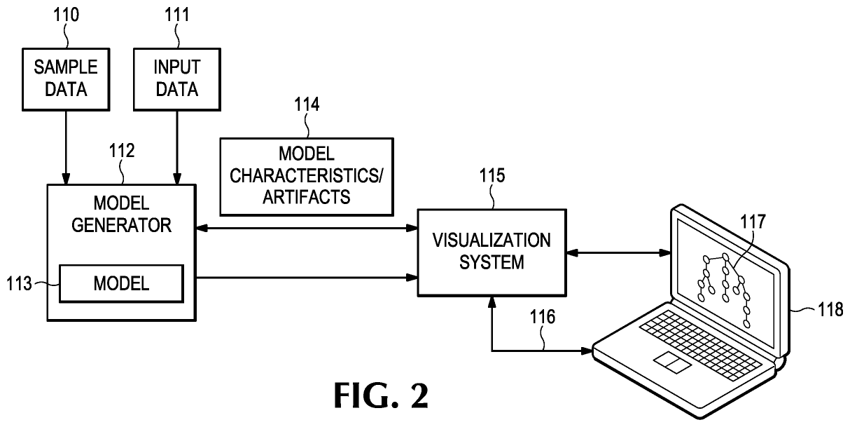

FIG. 2 depicts an example of a visualization system 115 that improves the visualization and understandability of decision trees. A model generator 112 may generate a data model 113 from sample data 110. For example, sample data 110 may comprise census data that includes information about individuals, such as education level, gender, family income history, address, etc. Of course this is just one example of any model that may be generated from any type of data. Sample data may comprise any kind of data hierarchical or otherwise from which model generator 112 may create a data model 113.

Model generator 112 may generate a decision tree 117 that visually represents model 113 as a series of interconnected nodes and branches. The nodes may represent questions and the branches may represent possible answers to the questions. Model 113 and the associated decision tree 117 can then be used to generate predictions or answers for input data 111. For example, model 113 and decision tree 117 may use financial and educational data 111 about an individual to predict a future income level for the individual or generate an answer regarding a credit risk of the individual. Model generators, models, and decision trees are known to those skilled in the art and are therefore not described in further detail.

As explained above, it may be difficult to clearly display decision tree 117 in an original raw form. For example, there may be too many nodes and branches, and too much text to clearly display the entire decision tree 117. A user may try to manually zoom into specific portions of decision tree 117 to more clearly view a subset of nodes and branches. However, zooming into a specific area may prevent a viewer from seeing other more important decision tree information and visually comparing information in different parts of the decision tree.

Visualization system 115 may automatically prune decision tree 117 and only display the most significant nodes and branches. For example, a relatively large amount of sample data 110 may be used for generating or training a first portion of decision tree 117 and a relatively small amount of sample data 110 may be used for generating a second portion of decision tree 117. The larger amount of sample data may allow the first portion of decision tree 117 to provide more reliable predictions than the second portion of decision tree 117.

Visualization system 115 may only display the nodes from decision tree 117 that receive the largest amounts of sample data. This allows the user to more easily view the key questions and answers in decision tree 117. Visualization system 115 also may display the nodes in decision tree in different colors that are associated with node questions. The color coding scheme may visually display node-question relationships, question-answer path relationships, or node-output relationships without cluttering the decision tree with large amounts of text. More generally, visualization system 115 may display nodes or branches with different design characteristics depending on particular attributes of the data. In an embodiment, visualization system 115 may show nodes or branches in different colors depending on an attribute of sample data 110 or input data 111, e.g., age or may show nodes or branches with different design characteristics, e.g., hashed, dashed, or solid lines or thick or thin lines, depending on another attribute of the data, e.g., sample size, number of instances, and the like.

Visualization system 115 may vary how decision tree 117 is pruned, color coded, and generally displayed on a computer device 118 based on model artifacts 114 and user inputs 116. Model artifacts 114 may comprise any information or metrics that relate to model 113 generated by model generator 112. For example, model artifacts 114 may identify the number of instances of sample data 110 received by particular nodes within decision tree 117, the fields and outputs associated with the nodes, and any other metric that may indicate importance levels for the nodes.

Instances may refer to any data that can be represented as a set of attributes. For example, an instance may comprise a credit record for an individual and the attributes may include age, salary, address, employment status, etc. In another example, the instance may comprise a medical record for a patient in a hospital and the attributes may comprise age, gender, blood pressure, glucose level, etc. In yet another example, the instance may comprise a stock record and the attributes may comprise an industry identifier, a capitalization value, and a price to earnings ratio for the stock.

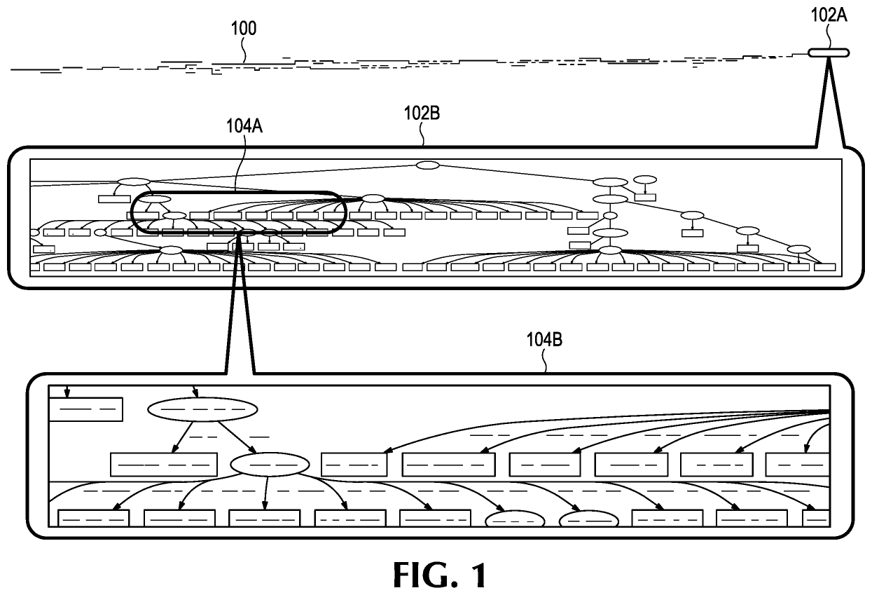

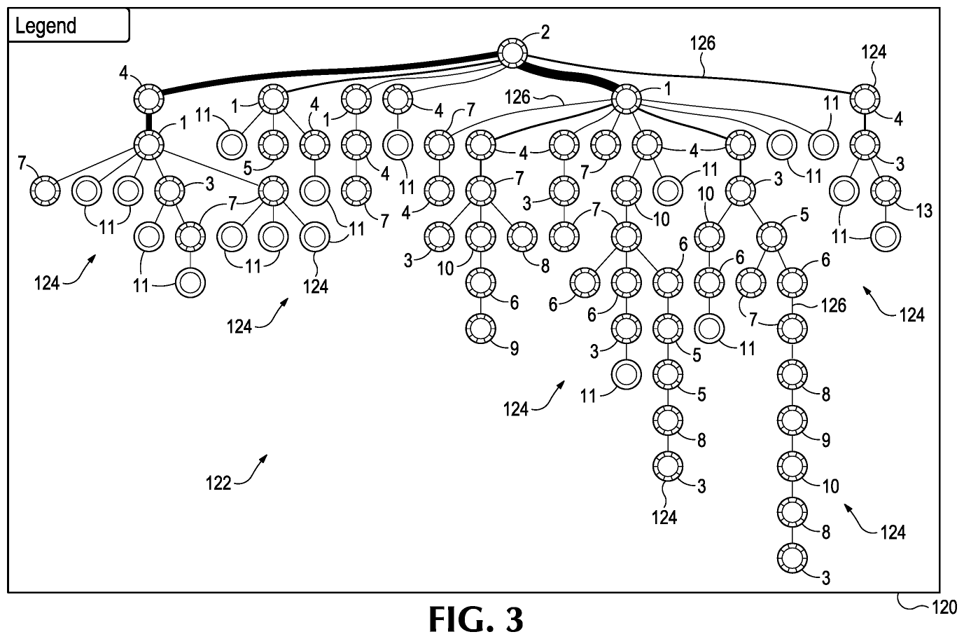

The idea is a system for visualizing generic decision trees using visualization and interaction techniques appropriate for various web clients such as handheld, notebook, or desktop computers. An example of the interface is shown in FIG. 3. FIG. 3 depicts an example decision tree 122 generated by the visualization system and displayed in an electronic page 120. The “pruned” tree representation of the data in FIG. 1 can be seen in FIG. 3. The decision tree 122 may comprise a series of nodes 124 connected together via branches 126. Nodes 124 may be associated with questions, fields and/or branching criteria and branches 126 may be associated with answers to the node questions. For example, a node 124 may ask the question is an individual over the age of 52. A first branch 126 connected to the node 124 may be associated with a yes answer and a second branch 126 connected to the node 124 may be associated with a no answer.

For explanation purposes, any field, branching criteria, or any other model parameters associated with a node may be referred to generally as a question and any parameters, data or other branching criteria used for selecting a branch will be referred to generally as an answer.

As explained above, the visualization system 115 may automatically prune decision tree 122 and not show all of the nodes and branches that originally existed in the raw non-modified decision tree model. Pruned decision tree 122 may include fewer nodes than the original decision tree but may be easier to understand and display the most significant portions of the decision tree. Nodes and branches for some decision tree paths may not be displayed at all. Other nodes may be displayed but the branches and paths extending from those nodes may not be displayed.

For example, the model generator may generate an original decision tree from sample data containing records for 100 different individuals. The record for only one individual may pass through a first node in the original decision tree. Dozens of records for other individuals may pass through other nodes in the original decision tree. The visualization system 115 may automatically prune the first node from decision tree 122.

In addition to being too large, raw decision trees may be difficult to interpret because of the large amounts of textual information. For example, the textual information may identify the question, field, and/or branching criteria associated with the nodes. Rather than displaying text, the visualization system may use a series of colors, shades, images, symbols, or the like, or any combination thereof to display node information.

For illustrative purposes, reference numbers are used to represent different colors. For example, some nodes 124 may be displayed with a color 1 indicating a first question/field/criteria. A second set of nodes 124 may be displayed with a color 2 indicating a second question/field/criteria, etc.

Nodes 124 with color 1 may ask a same first question, such as the salary of an individual and all of nodes 124 with color 2 may ask a same second question, such as an education level of the individual. Nodes 124 with the same color may have different thresholds or criteria. For example, some of nodes 124 with color 1 may ask if the salary for the individual is above $50K per year and other nodes 124 with color 1 may ask if the salary of the individual is above $80K.

The number of node colors may be limited to maintain the ability to discriminate between the colors. For example, only nodes 124 associated with a top ten key questions may be assigned colors. In order to better utilize the available colors, the visualization analyzes the “most important” fields or outputs used in the decision tree. This is determined by counting the amount of training data that each node receives. The top approximately 12 fields will receive a unique color, while the remaining nodes will receive a neutral grey color. Other nodes 124 may be displayed in decision tree 122 but may be associated with questions that did not receive enough sample data to qualify as one of the top ten key questions. Nodes 124 associated with the non-key questions may all be assigned a same color or may not be assigned any color.

Instead of being associated with questions, some nodes 124 in decision tree 124 may be associated with answers, outcomes, predictions, outputs, etc. For example, based on the questions and answers associated with nodes along a path, some nodes 124 may generate an answer “bad credit” and other nodes may generate an answer “good credit.” These nodes 124 are alternatively referred to as terminal nodes and may be assigned a different shape and/or color than the branching question nodes.

For example, the center section of all terminal nodes 124 may be displayed with a same color 11. In addition, branching nodes 124 associated with questions may be displayed with a hatched outline while terminal nodes 124 associated with answers, outcomes, predictions, outputs, etc. may be displayed with a solid outline. For explanation purposes, the answers, outcomes, predictions, outputs, etc. associated with terminal nodes may be referred to generally as outputs.

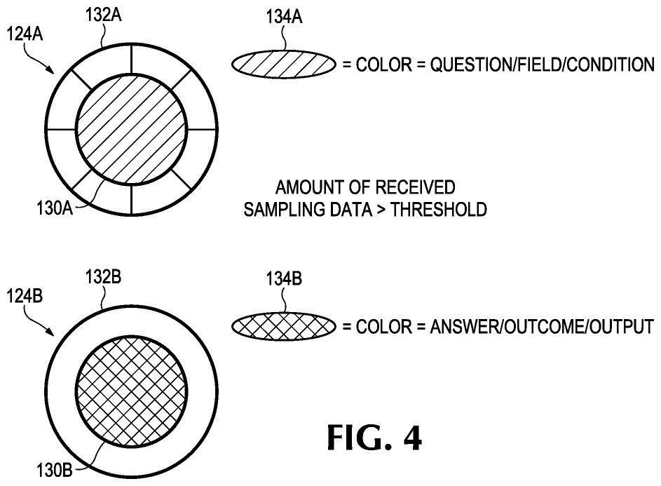

FIG. 4 depicts in more detail examples of two nodes 124 that may be displayed in decision tree 122 of FIG. 3. A branching node 124A may comprise a dashed outer ring 132A with a hatched center section 130A. The dashed outer ring 132A may visually indicate node 124A is a branching node associated with a question, field and/or condition. A color 134A within center section 130A is represented by hatched lines and may represent the particular question, field, and/or criteria associated with node 124A. For example, the question or field may be age and one example of criteria for selecting different branches connected to the node may be an age of 52 years.

Color 134A not only visually identifies the question associated with the node but also may visually identify the question as receiving more than some threshold amount of the sample data during creation of the decision tree model. For example, only the nodes associated with the top ten model questions may be displayed in decision tree 122. Thus, each of nodes 124A in the decision tree will be displayed with one of ten different colors.

A terminal node 124B may comprise a solid outer ring 132B with a cross-hatched center section 130B. A color 134B within center section 130B is represented by the cross-hatched lines. The solid outer ring 132B and color 130B may identify node 124B as a terminal node associated with an answer, outcome, prediction, output, etc. For example, the output associated with terminal node 124B may comprise an income level for an individual or a confidence factor a person is good credit risk.

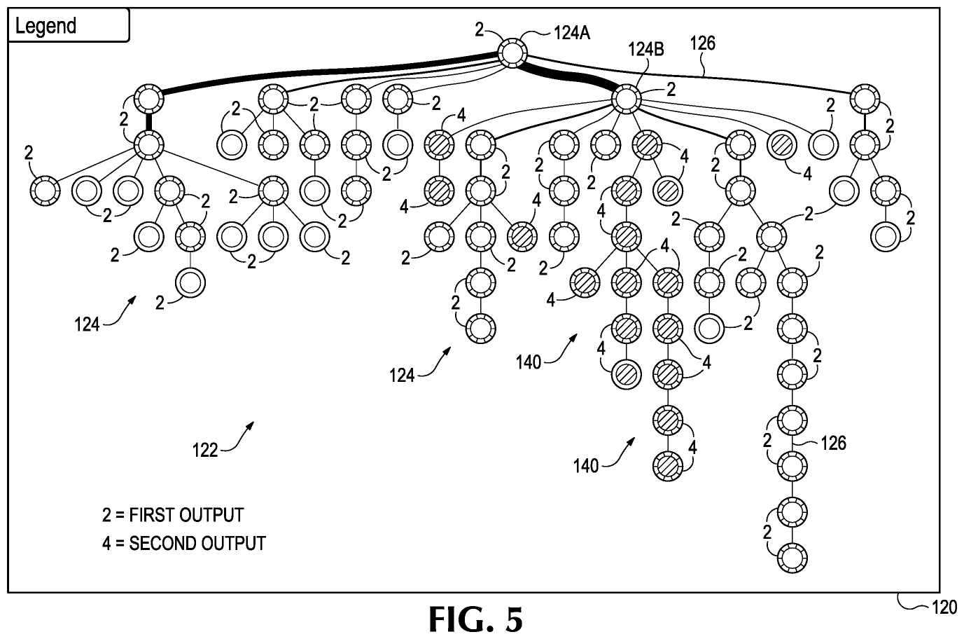

FIG. 5 depicts another example decision tree visualization generated by the visualization system. In this example, a second visualization mode is used for encoding model information. The visualization system may initially display decision tree 122 with the color codes shown in FIG. 3. In response to a user input, the visualization system may toggle to display decision tree 122 with the color codes shown in FIG. 5.

Decision tree 122 in FIG. 5 may have the same organization of nodes 124 and branches 126 previously shown in FIG. 3. However, instead of the colors representing questions, the colors displayed in FIG. 5 may be associated with answers, outcomes, predictions, outputs, etc. For example, a first set of nodes 124 may be displayed with a first color 2 and a second set of nodes 124 may be displayed with a second color 4. Color 2 may be associated with the output “good credit” and color 4 may be associated with the output “bad credit.” Any nodes 124 within paths of decision tree 122 that result in the “good credit” output may be displayed with color 2 and any nodes 124 within paths of decision tree 122 that result in the “bad credit” output may be displayed with color 4.

A cluster 140 of bad credit nodes with color 4 are displayed in a center portion of decision tree 122. A user may mouse over cluster 140 of nodes 124 and view the sequence of questions that resulted in the bad credit output. For example, a first question associated with node 124A may be related to employment status and a second question associated with a second lower level node 124B may be related to a credit check. The combination of questions for nodes 124A and 124B might identify the basis for the bad credit output associated with node cluster 140.

The visualization system may generate the colors associated with the outputs based on a percentage of sample data instances that resulted in the output. For example, 70 percent of the instances applied to a particular node may have resulted in the “good credit” output and 30 percent of the instances through the same node may have resulted in the “bad credit” output. The visualization system may assign the color 2 to the node indicating a majority of the outputs associated with the node are “good credit.”

In response to a second user input, the visualization system may toggle back to the color coded questions shown in FIG. 3. The visualization system may display other information in decision tree 122 in response to preconfigured parameters or user inputs. For example, a user may direct the visualization system to only display paths in decision tree 122 associated with the “bad credit” output. In response to the user input, the visualization system may filter out all of the nodes in decision tree 122 associated with the “good credit” output. For example, only the nodes with color 4 may be displayed.

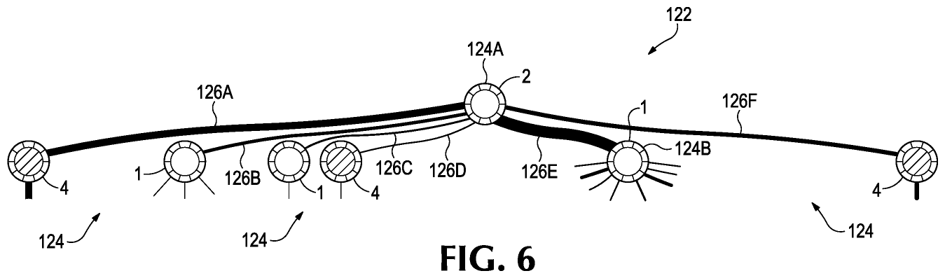

FIG. 6 depicts an example of how the visualization system displays amounts of sample data used for creating the decision tree. As discussed above, decision tree 122 may be automatically pruned to show only the most significant nodes 124 and branches 126. The visualization system may vary the width of branches 126 based on the amounts of sample data received by different associated nodes 124.

For example, a root level of decision tree 122 is shown in FIG. 6 and may have six branches 126A-126F. An order of thickest branch to thinnest branch comprises branch 126E, branch 126A, branch 126F, branch 126B, branch 126C, and branch 126D. In this example, the most sample data may have been received by node 124B. Accordingly, the visualization system displays branch 126E as the widest or thickest branch.

Displaying the branch thicknesses allow users to more easily extract information from the decision tree 122. For example, node 124A may be associated with an employment question, node 124B may be associated with a credit question, and branch 126E may be associated with an answer of being employed for less than 1 year. Decision tree 122 shows that the largest amount of the sample data was associated with persons employed for less than one year.

The thickness of branches 126 also may visually indicate the reliability of the outputs generated from different branches and the sufficiency of the sample data used for generating decision tree 122. For example, a substantially larger amount of sample data was received by node 124B through branch 126E compared with other nodes and branches. Thus, outputs associated with node 124B and branch 126E may be considered more reliable than other outputs.

A user might also use the branch thickness to identify insufficiencies with the sample data. For example, the thickness of branch 126E may visually indicate 70 percent of the sample data contained records for individuals employed less than one year. This may indicate that the decision tree model needs more sample data for individuals employed for more than one year. Alternatively, a user may be confident that the sample data provides an accurate representation of the test population. In this case, the larger thickness of branch 126E may simply indicate that most of the population is usually only employed for less than one year.

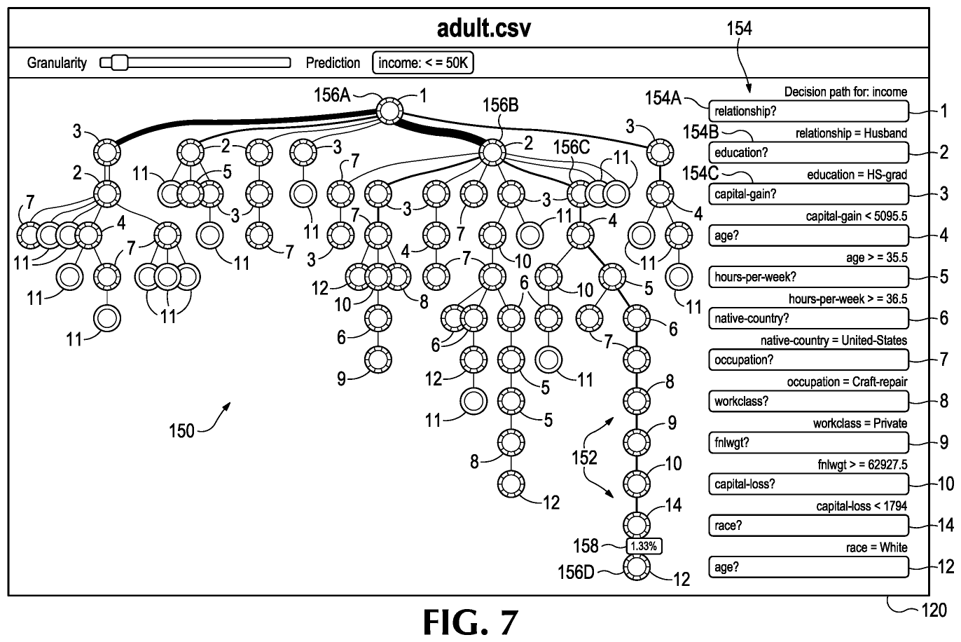

FIG. 7 depicts a scheme for displaying a path through of a decision tree. The colorization schemes described above allow quick identification of important questions. However, a legend 154 also may be used to visually display additional decision tree information.

For example, a user may select or hover a cursor over a particular node within a decision tree 150, such as node 156D. The visualization system may identify a path 152 from selected node 156D to a root node 156A. The visualization system then may display a color coded legend 154 on the side of electronic page 120 that contains all of the questions and answers associated with all of the nodes within path 152.

For example, a relationship question 154A associated with root node 156A may be displayed in box with color 1 and node 156A may be displayed with color 1. An answer of husband to relationship question 154A may cause the model to move to a node 156B. The visualization system may display question 154B associated with node 156B in a box with the color 2 and may display node 156B with color 2. An answer of high school to question 154B may cause the model to move to a next node 156C. The visualization system may display a capital gain question 154C associated with node 156C with the color 3 and may display node 156C with color 3.

The visualization system may display other metrics or data values 158. For example, a user may reselect or continue to hover the cursor over node 156D or may select a branch connected to node 156D. In response to the user selection, the visualization system may display a popup window that contains data 158 associated with node 156D. For example, data 158 may indicate that 1.33% of the sample data instances reached node 156D. As mentioned above, instances may comprise any group of information and attributes used for generating decision tree 150. For example, an instance may be census data associated with an individual or may be financial information related to a stock.

Thus, legend 154 displays the status of all the records at a split point along path 152, such as relationship=Husband. Legend 154 also contains the question/field to be queried at the each level of decision tree path 152, such as capital-gain. Fields commonly used by decision tree 150 and significant fields in terms of maximizing information gain that appear closer to root node 156A can also be quickly viewed.

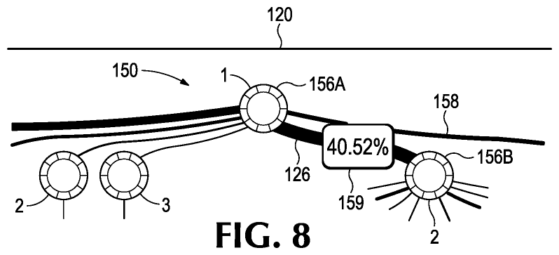

FIG. 8 depicts another example of how the visualization system may display metrics associated with a decision tree. As described above in FIG. 7, the visualization system may display a contextual popup window 159 in response to a user selection, such as moving a cursor over a node 156B or branch 126 and pressing a select button. Alternatively, the visualization system may display popup window 159 when the user hovers the cursor over node 156B or branch 126 for some amount of time or selects node 156B or branch 126 via a keyboard or touch screen.

Popup window 159 may display numeric data 158 identifying a percentage of records (instances) in the sample data that passed through node 156B during the model training process. The record information 158 may help a user understand other aspects of the underlying sample data. Data 158 may correspond with the width of branch 126. For example, the width of branch 126 visually indicates node 156B received a relatively large percentage of the sample data. Selecting node 156B or branch 126 causes the visualization system to display popup window 159 and display the actual 40.52% of sample data that passed through node 156B.

Any other values or metrics can be displayed within popup window 159, such as average values or other statistics related to questions, fields, outputs, or attributes. For example, the visualization system may display a dropdown menu within popup window 159. The user may select different metrics related to node 156B or branch 126 for displaying via selections in the dropdown menu.

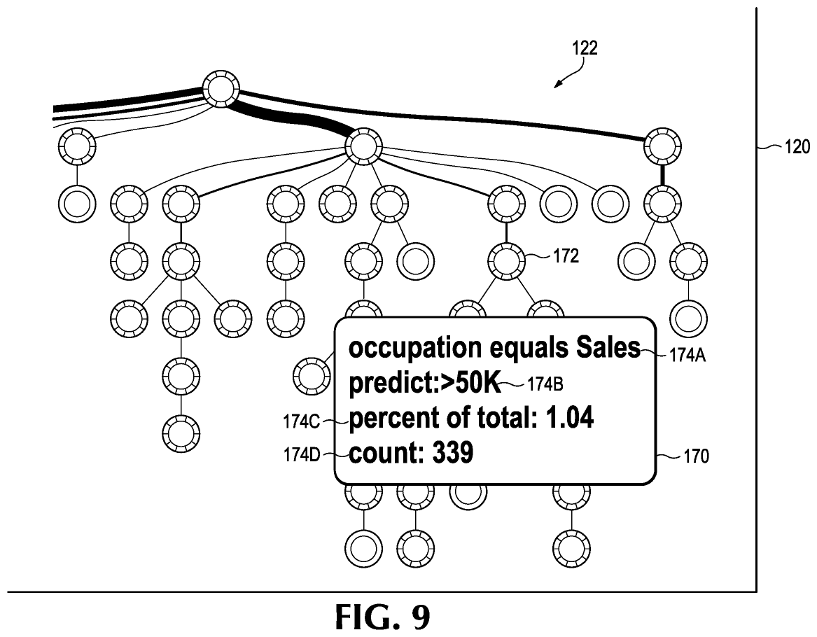

FIG. 9 depicts another popup window 170 that may be displayed by the visualization system in response to the user selecting or hovering over a node 172. Popup window 170 may display text 174A identifying the question associated with node 172 and display text 174B identifying a predicted output associated with node 172. Popup window 170 also may display text 174D identifying a number of sample data instances received by node 172 and text 174C identifying a percentage of all sample data instances that were passed through node 172.

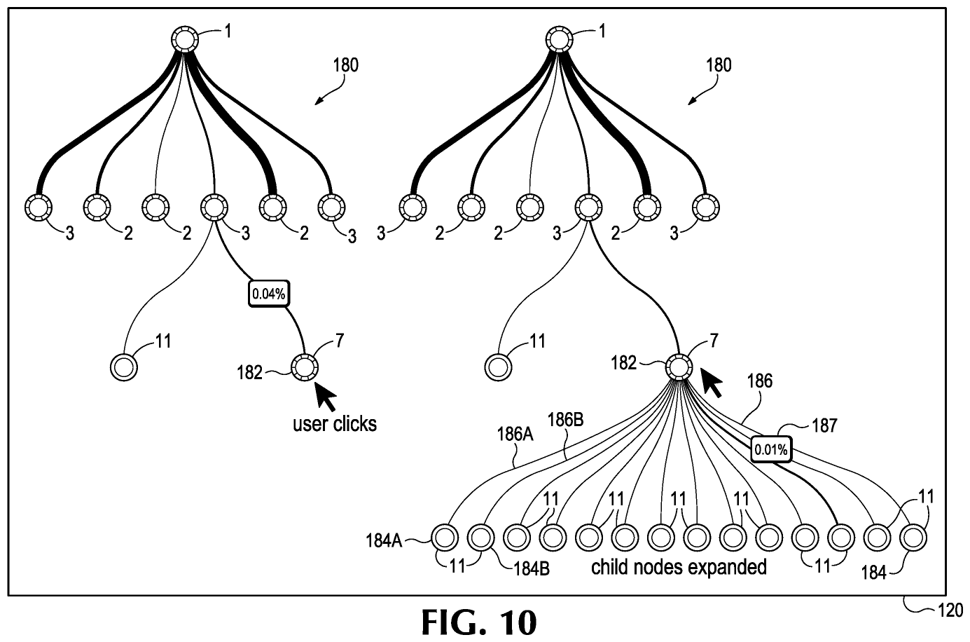

FIG. 10 depicts how the visualization system may selectively display different portions of a decision tree. As described above, the visualization system may initially display a most significant portion of a decision tree 180. For example, the visualization system may automatically prune decision tree 180 by filtering child nodes located under a parent node 182. A user may wish to expand parent node 182 and view any hidden child nodes.

In response to the user selecting or clicking node 182, the visualization system may display child nodes 184 connected below parent node 182. Child nodes 184 may be displayed with any of the color and/or symbol coding described above. In one example, the visualization system may isolate color coding to child nodes 184. For example, the top ranked child nodes 184 may be automatically color coded with associated questions. The visualization system also may display data 187 related to child nodes 184 in popup windows in response to the user selecting or hovering over child nodes 184 or selecting branches 186 connected to child nodes 184.

In order to keep the decision tree from getting too dense, branches 186 of the child node subtree may be expanded one at a time. For example, selecting parent node 182 may display a first branch 186A and a first child node 184A. Selecting parent node 182 a second time may display a second branch 186B and a second child node 184B.

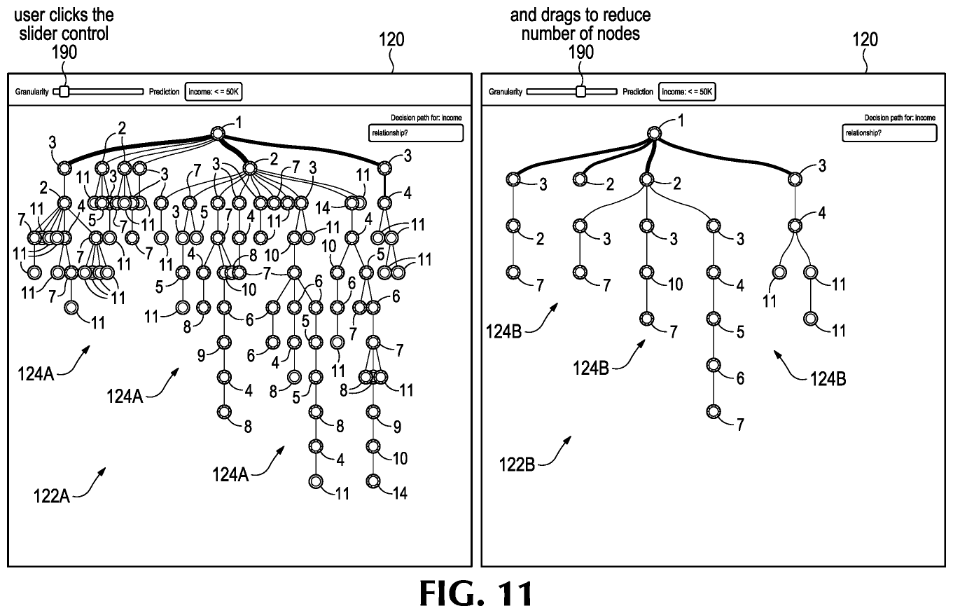

FIG. 11 depicts another example of how the visualization system may selectively prune a decision tree. The visualization system may display a preselect number of nodes 124A in decision tree 122A. For example, the visualization system may identify 100 nodes from the original decision tree that received the highest amounts of sample data and display the identified nodes 124A in decision tree 122A.

A user may want to selectively prune the number of nodes 124 that are displayed in decision tree 122B. This may greatly simplify the decision tree model. An electronic image or icon represents a slider 190 and may be used for selectively varying the number of nodes displayed in the decision tree. As mentioned above, the top 100 nodes 124A may be displayed in decision tree 122A. Moving slider 190 to the right may cause the visualization system to re-pruned decision tree 124A into decision tree 124B with a fewer nodes 124B.

For example, the visualization system then may identify a number of nodes to display in decision tree 122B based on the position of slider 190, such as 20 nodes. The visualization system may then identify the 20 nodes and/or 20 questions that received the largest amount of sample data and display the identified nodes 124B in decision tree 122B. The visualization system may display nodes 124B with colors corresponding with the associated node questions. The visualization system also may display any of the other information described above, such as color coded outputs and/or popup windows that display other mode metrics.

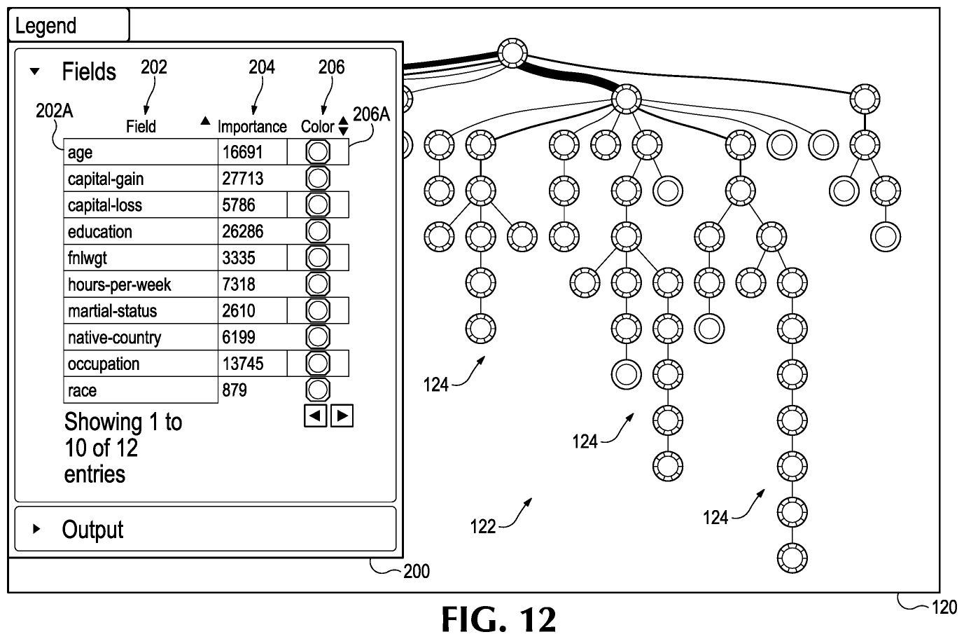

FIG. 12 depicts another example of how the visualization system may display a decision tree. The colorization techniques described above allow the important fields to be quickly identified. The visualization system may display a legend 200 that shows the mapping of colors 206 with corresponding fields 202. Legend 200 may be used for changing colors 206 assigned to specific questions/fields 202 or may be used to change an entire color scheme for all fields 202. For example, selecting a particular field 202A on legend 200 may switch the associated color 206A displayed for nodes 124 associated with field 202A.

Legend 200 also may display values 204 associated with the importance 204 of different fields/questions/factors 202 used in a decision tree 122. For example, decision tree 122 may predict salaries for individuals. Field 202A may have an importance value of 16691 which appears to have the third highest importance within fields 202. Thus, age field 202A may be ranked as the third most important question/field in decision tree 122 for predicting the salary of an individual. Any statistics can be used for identifying importance values 204. For example, importance values 204 may be based on the confidence level for fields 202.

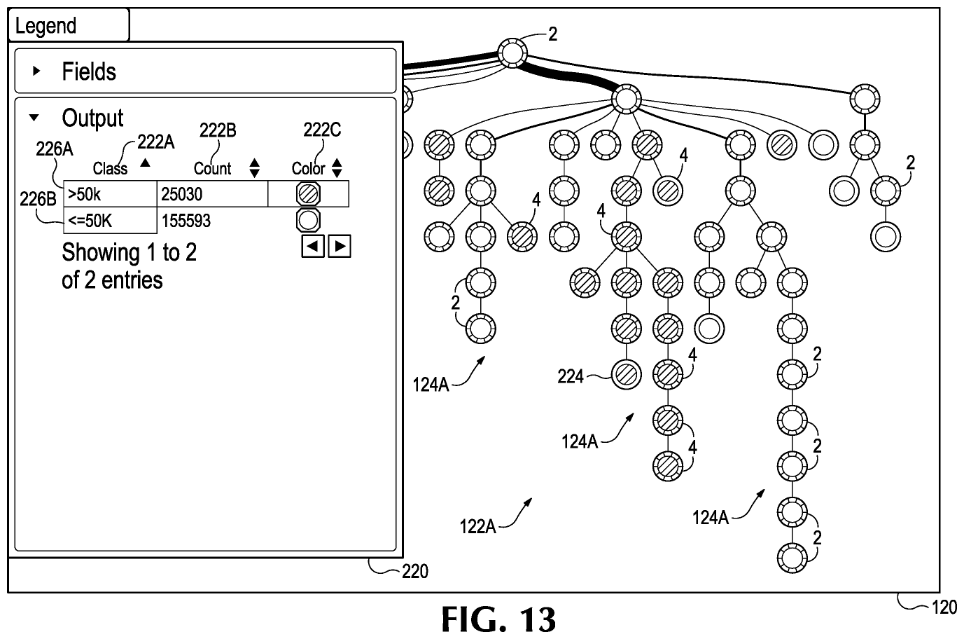

FIG. 13 depicts another example of how output information may be displayed with a decision tree. A legend 220 may be displayed in response to a user selecting a given node. In this example, the user may have selected a node 224 while operating in the output mode previously described in FIG. 5. Accordingly, the visualization system may display legend or window 220 containing output metrics associated with node 224.

For example, legend 220 may display outputs or classes 222A associated with node 224 or the output associated with node 224, a count 222B identifying a number of instances of sample data that generated output 222A, and a color 222C associated with the particular output. In this example, an output 226A of >50K may have a count 222B of 25030 and an output 226B of ≤50K may have a count 222B of 155593.

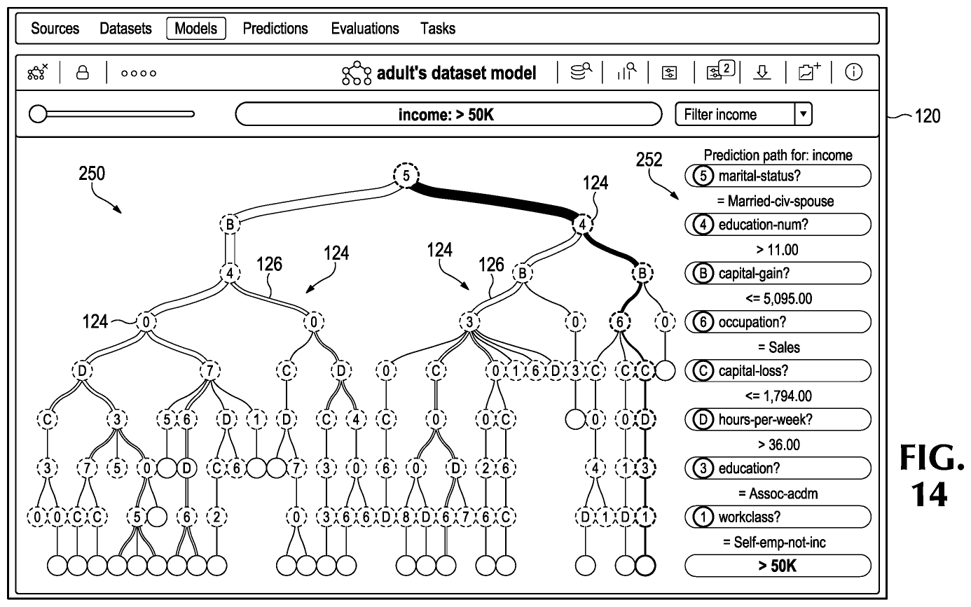

FIG. 14 depicts an alternative example of how questions and answers may be visually displayed in a decision tree 250. In this example, instead of colors, numbers and/or letters may be displayed within nodes 124. The alphanumeric characters may represent the questions, fields, conditions and/or outputs associated with the nodes and associated branches 126. A legend 252 may be selectively displayed on the side of electronic page 120 that shows the mappings between the alphanumeric characters and the questions, fields, answers, and outputs. Dashed outlines circles again may represent branching nodes and solid outlined circles may represent terminal/output nodes.

Hardware and Software

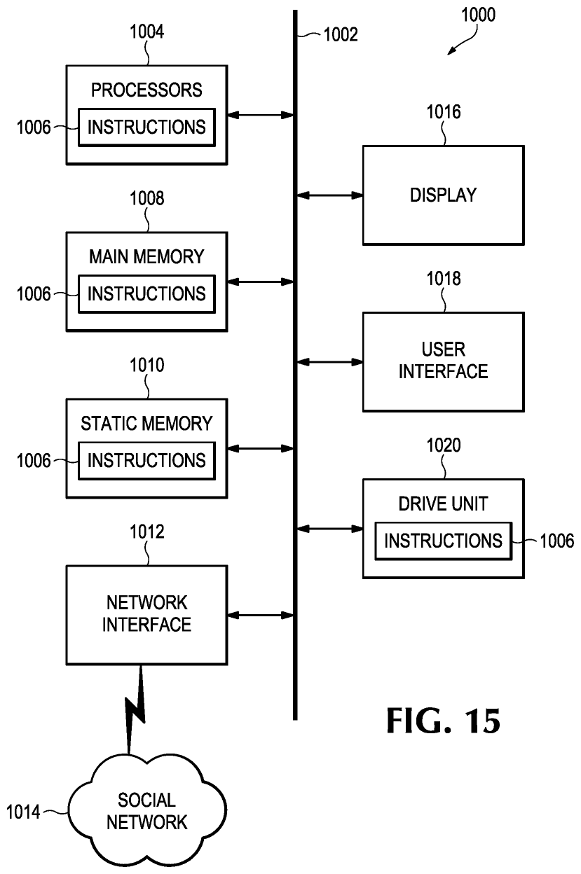

FIG. 15 shows a computing device 1000 that may be used for operating the visualization system and performing any combination of the visualization operations discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise a storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program, or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A method of generating a visualization of a predictive analytics data model in a computing device, the method comprising:
accessing the predictive analytics data model;
wherein the predictive analytics data model is based on plural instances of sample data and is usable by a processor to algorithmically generate a result based on input data;
generating visualization data for the predictive analytics model, the visualization data including a decision tree comprising multiple nodes and branches, the nodes including a single root node and a plurality of terminal nodes;
wherein each terminal node has a corresponding unique path, defined by a series of the branches and nodes, extending between the root node and the terminal node;
in the computing device, identifying metrics associated with the decision tree, the metrics including corresponding numbers of instances of the sample data associated with respective nodes and branches; and
in the computing device, automatically modifying the visualization data, without user input, by filtering out portions of the decision tree based on the numbers of instances of the sample data, without modifying the prediction analytics model;
wherein the filtered portions correspond to the nodes and branches that represent less than a threshold number of instances of the sample data;
wherein the filtering comprises:
selecting N questions from among the questions represented as nodes in the decision tree that are not terminal nodes, wherein each one of the N selected questions is associated with a respective number of instances of the sample data that is greater than the number of instances associated with each one of the questions that are not among the selected N questions;
identifying the nodes in the tree that are associated with each of the N selected question; and
filtering the display by displaying only a portion of the tree that comprises the identified nodes and branches interconnecting the identified nodes; and
in the computing device, generating the visualization of the predictive analytics model using the automatically modified visualization data and displaying both:
said modified visualization, and the remaining, unfiltered portion of the decision tree, on an electronic display screen.
